(19) United States
(12) Patent Application Publication
(10) Pub. No.: US 2009/0266662 A1
(43) Pub. Date: Oct. 29, 2009

(54) Shock absorption apparatus for a treadmill

(76) Inventor: Chen-Hui Ko, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,184

(22) Filed: Apr. 29, 2008

(51) Int. Cl. F16F 9/00; A63B 22/02

(52) U.S. Cl. 188/322.19; 482/54

(57) ABSTRACT

A shock absorption apparatus for a treadmill interposed between a lifting frame and a running board, comprising: a) a fixing tube having one end fixed on the lifting frame, a positioning member, a locating gear, a locating member, and a damping spring being placed into the fixing tube one after another; b) a sleeve mounted at the external circumference of the fixing tube; c) a push tube having one end fixed on the running board, the other end of the push tube being extended into the fixing tube in such a manner that the push tube is screwed with a locating gear and a locating member, the locating member, the sleeve, and the push tube being interlocked by means of a locating screw; and d) a shock absorption regulator having an adjusting gear set, a motor, and a housing, the adjusting gear set and the motor being received within the housing, the housing being mounted by a fixing member on the external circumference of the sleeve, a drive gear of the adjusting gear being engaged with the locating gear. Unlike the conventional structure having a bad damping effect and being incapable of adjustment of the damping effect, an excellent damping effect is ensured by the configuration according to the invention. Moreover, a continuous adjustment of the damping action is achieved.

### BACKGROUND OF THE INVENTION

1. Field of the Invention

The invention relates to a shock absorption apparatus for a treadmill, and more particularly to an apparatus in which the drive force of a motor enables the rotation of a locating gear via a drive gear. The rotation of the locating gear 54 will be transformed into the drive force to lift or lower the push tube. Meanwhile, the locating member and the sleeve interlocked with the push tube will be moved therewith. As a result, a continuous adjustment of the precompression of the damping spring is ensured.

2. Description of the Related Art

As shown in FIG. 1, a conventional treadmill has a lifting frame 20 on a base 10. A running board 30 and a continuous moving belt 40 is mounted on the lifting frame 20. In order to enhance the comfort in use, the running board 30 is normally provided with a damping mechanism such as cushioning pads which are interposed between the running board 30 and the lifting frame 20. Alternatively, a soft pad layer (not shown) is disposed on the running board 30 such that the continuous moving belt 40 achieves the cushioning effect. However, this mechanism is lacking of the integrity of the structure, has the bad damping effect, and is not adjustable. The reason lies in that the lifting frame 20 and the running board 30 are a rigid design. Therefore, the feet of the operator are also subject to a great reactive force when the operator walks on the continuous moving belt 40 even if the cushioning pads or the soft pad layer are provided. In addition to discomfort, the feet will get an exercise injury in use for a longer time.

### SUMMARY OF THE INVENTION

An object of the invention is to eliminate the above-mentioned drawbacks and to provide a shock absorption apparatus for a treadmill having an excellent damping effect and achieving a continuous adjustment of the damping action.

Another object of the invention is to provide a shock absorption apparatus for a treadmill that ensures a practical adjustment of the elevation of the walking exercise.

In order to achieve the above-mentioned objects, a shock absorption apparatus for a treadmill in accordance with the invention is interposed between a base and a lifting frame and provided with:

a) a fixing tube having one end fixed on a housing of an elevation adjusting unit, a positioning body being formed at the internal side of the other end of the fixing tube, a positioning member, a locating gear, a locating member, and a damping spring being placed into the fixing tube one after another, a first slide slot and a second slide slot being formed in the tube wall;

b) a sleeve mounted at the external circumference of the fixing tube and having a first through hole and a second through hole corresponding to the first and second slide slots of the fixing tube, respectively;

c) a push tube having one end fixed on the lifting frame, the other end of the push tube being extended into the fixing tube in such a manner that the push tube is screwed with a locating gear and a locating member, the locating member, the sleeve, and the push tube being interlocked by means of a locating screw passing through the first through hole and the first slide slot;

d) a shock absorption regulator having an adjusting gear set, a motor, and a housing, the adjusting gear set and the motor being received within the housing, the housing being mounted by a fixing member on the external circumference of the sleeve, a drive gear of the adjusting gear set passing through the second through hole and the second slide slot in such a way that the drive gear is engaged with the locating gear; and

e) an elevation adjusting unit having a transmission gear set installed within a housing, a transmission bar and the transmission gear set creating a power transmission unit, one end of the transmission bar being pivotally connected to the base while the other end thereof is extended into the damping spring and the push tube, a motor being employed to provide the drive force required by the transmission gear set.

### BRIEF DESCRIPTION OF THE DRAWINGS

The accomplishment of this and other objects of the invention will become apparent from the following descriptions and its accompanying figures of which:

FIG. 1 is a perspective view of a conventional treadmill;

FIG. 2 is an exploded perspective view of a shock absorption apparatus for a treadmill according to a first embodiment of the invention;

FIG. 3 is a perspective view of a shock absorption apparatus for a treadmill according to a first embodiment of the invention;

FIG. 4 is a side view of a shock absorption apparatus for a treadmill according to a first embodiment of the invention wherein the installation position thereof is illustrated;

FIG. 5 is a cutaway view of a shock absorption apparatus for a treadmill according to a first embodiment of the invention;

FIG. 6 is a cross-sectional view taken along line 6-6 of FIG. 5;

FIG. 7 is a cross-sectional view taken along line 6-6 of FIG. 5 wherein the adjustment state of the damping spring is illustrated;

FIG. 8 is a schematic drawing of a shock absorption apparatus for a treadmill according to a second embodiment of the invention;

FIG. 9 is a cross-sectional view taken along line 9-9 of FIG. 8;

FIG. 10 is a perspective view of a shock absorption apparatus for a treadmill according to a second embodiment of the invention wherein the transmission bar is a rack; and

FIG. 11 is a side view of a shock absorption apparatus for a treadmill according to a second embodiment of the invention wherein the installation position thereof is illustrated.

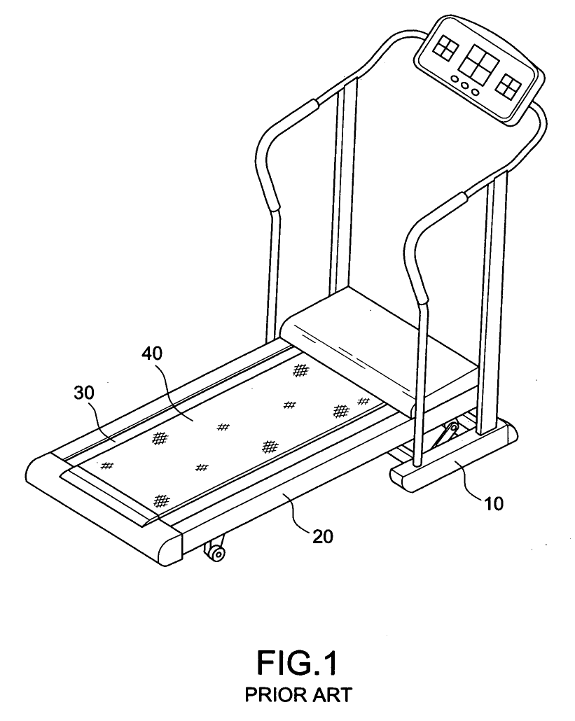

### DETAILED DESCRIPTION OF THE PREFERRED EMBODIMENT

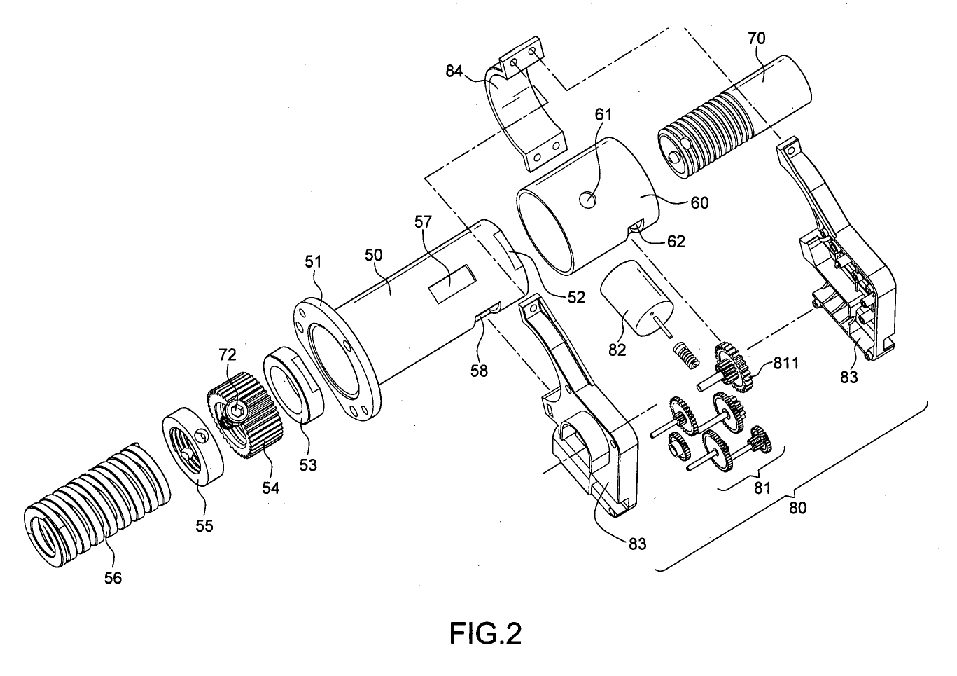

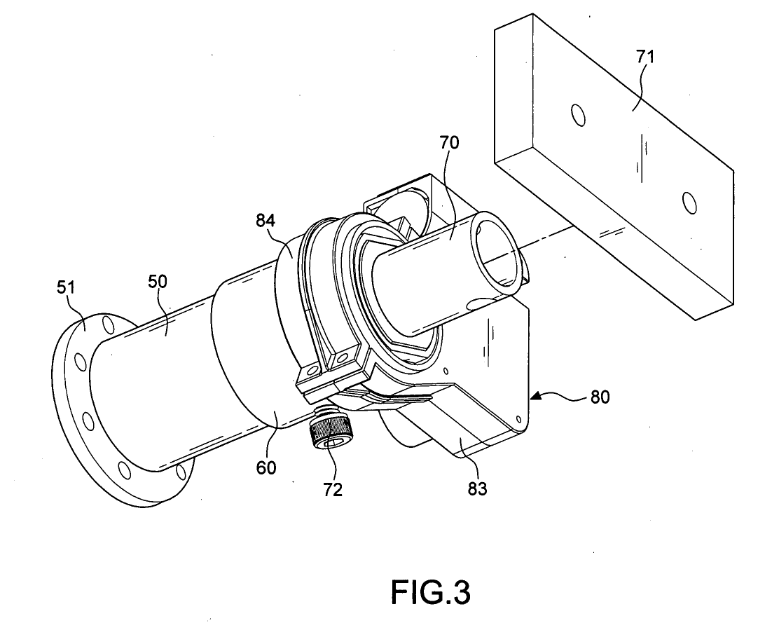

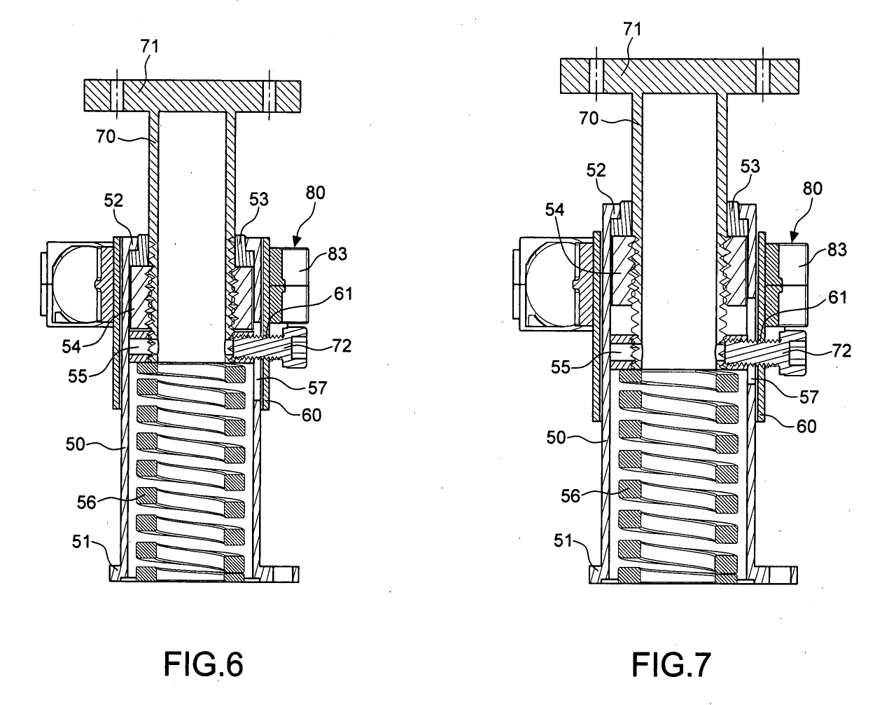

First of all, referring to FIGS. 2 through 7, a first embodiment of the invention interposed between a lifting frame 20 and a running board 30 includes a fixing tube 50, a sleeve 60, a push tube 70, and a shock absorption regulator 80.

The fixing tube 50 includes a flange 51 at one end thereof for fixing the fixing tube 50 on the lifting frame 20. A positioning body 52 is formed at the internal side of the other end of the fixing tube 50. A positioning member 53, a locating gear 54, a locating member 55, and a damping spring 56 are placed into the fixing tube 50 one after another. A first slide slot 57 and a second slide slot 58 are formed in the tube wall.

The sleeve 60 is mounted at the external circumference of the fixing tube 50 and includes a first through hole 61 and a second through hole 62 corresponding to the first and second slide slots 57, 58 of the fixing tube 50, respectively.

The push tube 70 includes a connection member 71 at one end thereof for fixing the push tube 70 on the running board 30. The other end of the push tube 70 is extended into the fixing tube 50 in such a manner that the push tube 70 is screwed with a locating gear 54 and a locating member 55. Meanwhile, the locating member 55, the sleeve 60 and the push tube 70 are interlocked by means of a locating screw 72 passing through the first through hole 61 and the first slide slot 57.

The shock absorption regulator 80 includes an adjusting gear set 81, a motor 82, and a housing 83. The adjusting gear set 81 and the motor 82 are received within the housing 83. The housing 83 is mounted by a fixing member 84 on the external circumference of the sleeve 60. Moreover, a drive gear 811 of the adjusting gear set 81 passes through the second through hole 62 and the second slide slot 58 in such a way that the drive gear 811 is engaged with the locating gear 54.

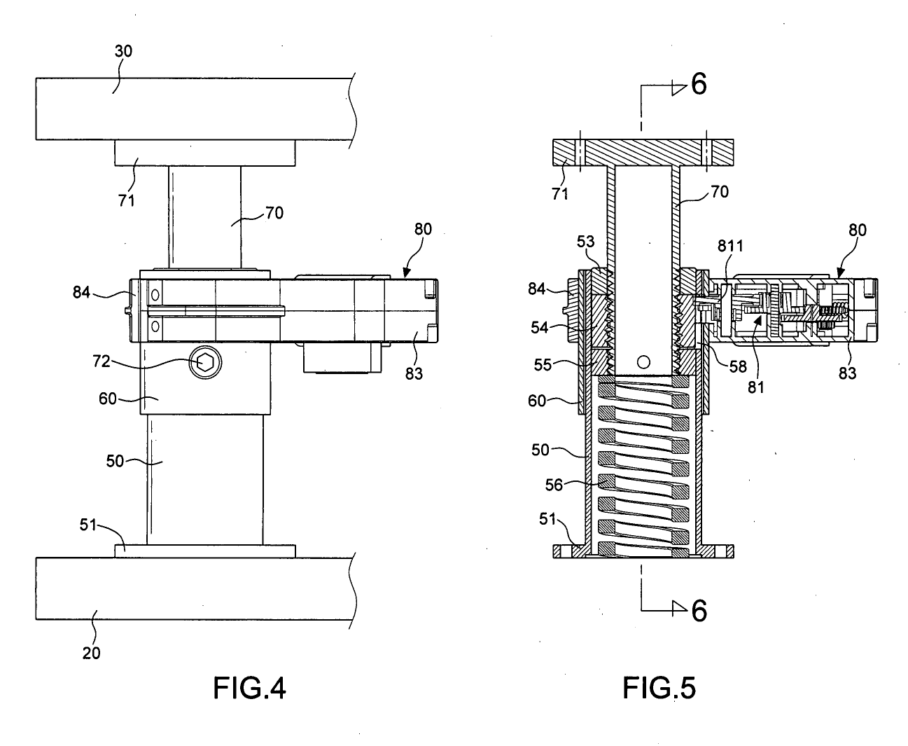

Based on the above-mentioned configuration, the push tube 70 brings the locating gear 54 and the locating member 55 in screwed connection with the push tube 70 in a lower position when the operator walks on the running board 30 and applies an impact force to the running board 30 (see FIGS. 4 through 7). At that time, the locating member 55 will be prevented from lowering by the resilience of the damping spring 56. In other words, the resilience of the damping spring 56 resists the impact force applied by the operator, thereby achieving an excellent damping effect.

In order to meet different requirements of the operators on the damping effect, the operators may control the motor 82 of the shock absorption regulator 80 through a control panel of the treadmill such that the drive force of the motor enables the rotation of the locating gear 54 via the drive gear 811 of the adjusting gear set 81. The rotation of the locating gear 54 will be transformed into the drive force to lift or lower the push tube 70. Meanwhile, the locating member 55 and the sleeve 60 interlocked with the push tube 70 will be moved therewith. As a result, a continuous adjustment of the precompression of the damping spring 56 is ensured, thereby meeting different requirements of the operators. In addition, an excellent damping effect is achieved. Furthermore, the damping action is steplessly adjustable.

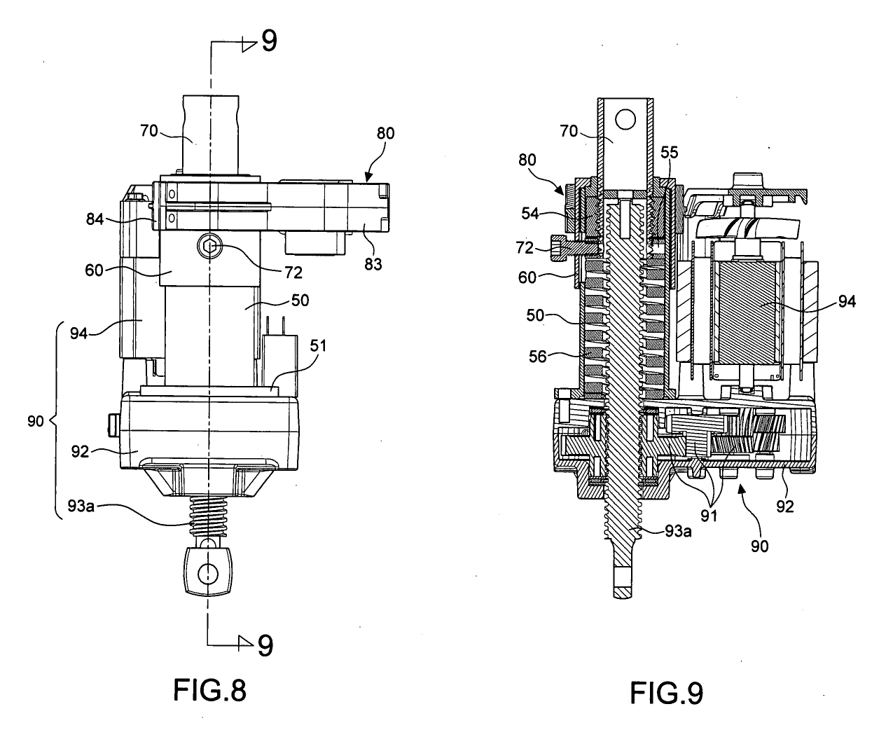

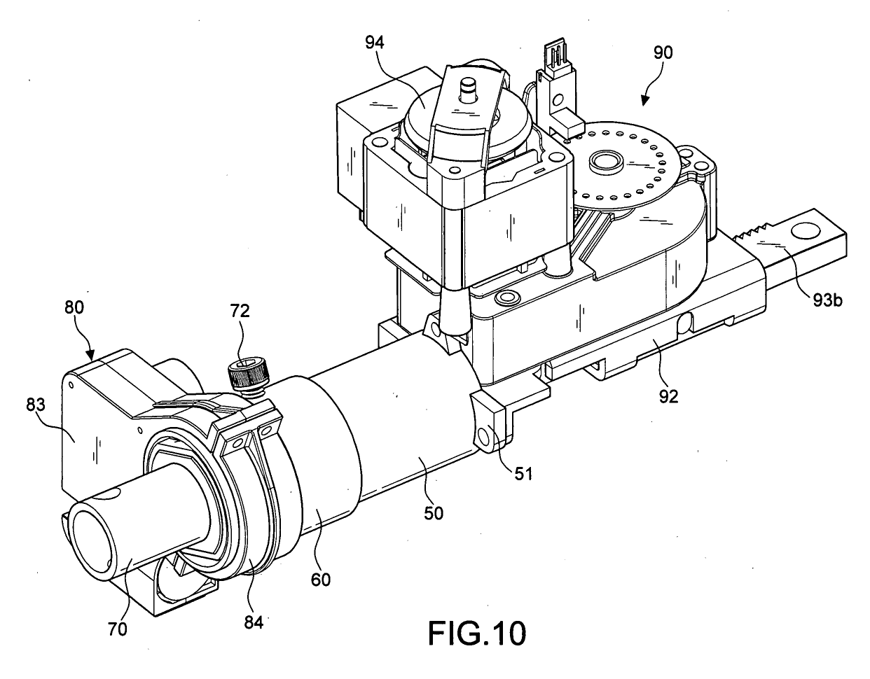

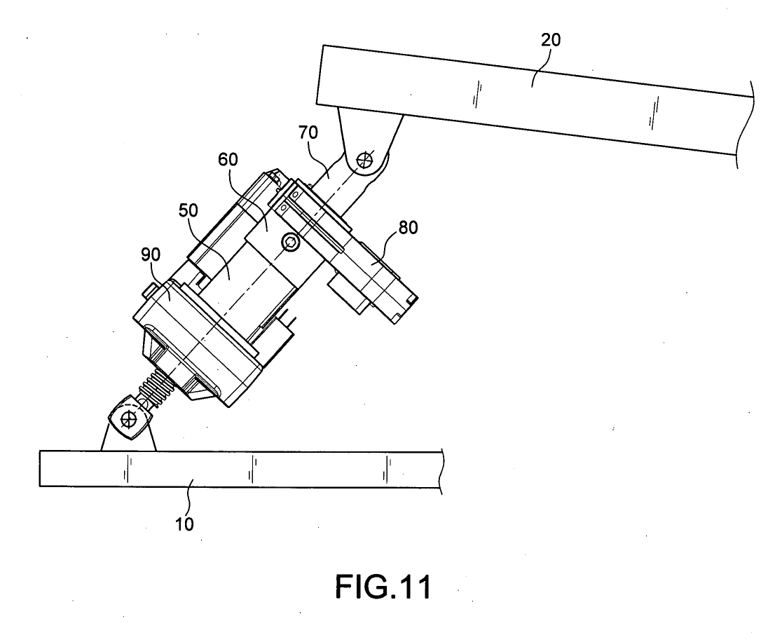

Referring to FIGS. 8 through 11, a second embodiment of the invention further includes an elevation adjusting unit 90 for the lifting frame 20 in addition to the entire structure of the first embodiment. The second embodiment interposed between a base 10 and the lifting frame 20 includes a fixing tube 50, a sleeve 60, a push tube 70, a shock absorption regulator 80, and the elevation adjusting unit 90.

The fixing tube 50 includes a flange 51 at one end thereof for fixing the fixing tube 50 on the elevation adjusting unit 90. A positioning body 52 is formed at the internal side of the other end of the fixing tube 50. A positioning member 53, a locating gear 54, a locating member 55, and a damping spring 56 are placed into the fixing tube 50 one after another. A first slide slot 57 and a second slide slot 58 are formed in the tube wall.

The sleeve 60 is mounted at the external circumference of the fixing tube 50 and includes a first through hole 61 and a second through hole 62 corresponding to the first and second slide slots 57, 58 of the fixing tube 50, respectively.

The push tube 70 includes a connection member 71 at one end thereof for fixing the push tube 70 on the lifting frame 20. The other end of the push tube 70 is extended into the fixing tube 50 in such a manner that the push tube 70 is screwed with a locating gear 54 and a locating member 55. Meanwhile, the locating member 55, the sleeve 60 and the push tube 70 are interlocked by means of a locating screw 72 passing through the first through hole 61 and the first slide slot 57.

The shock absorption regulator 80 includes an adjusting gear set 81, a motor 82, and a housing 83. The adjusting gear set 81 and the motor 82 are received within the housing 83. The housing 83 is mounted by a fixing member 84 on the external circumference of the sleeve 60. Moreover, a drive gear 811 of the adjusting gear set 81 passes through the second through hole 62 and the second slide slot 58 in such a way that the drive gear 811 is engaged with the locating gear 54.

The elevation adjusting unit 90 includes a transmission gear set 91 installed within a housing 92. A transmission bar such as a spindle 93a or a rack 93b is cooperated with the transmission gear set 91 to create a power transmission unit. One end of the transmission bar is pivotally connected to the base 10 while the other end thereof is extended into the damping spring 56 and the push tube 70. Meanwhile, a motor 94 is employed to provide the drive force required by the transmission gear set 91.

The joint of the transmission bar such as a spindle 93a or a rack 93b that is pivotally attached to the base 10 is extended or retracted relative to the housing 92 by means of the power provided by the motor 94 to the transmission gear set 91. In this way, the inclination of the lifting frame 20 relative to the base 10 is changed. As a result, the installation of the elevation adjusting unit 90 ensures a practical adjustment of the inclination in addition to the damping effect.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A shock absorption apparatus for a treadmill interposed between a lifting frame and a running board, comprising:
a) a fixing tube having one end fixed on the lifting frame, a positioning body being formed at the internal side of the other end of the fixing tube, a positioning member, a locating gear, a locating member, and a damping spring being placed into the fixing tube one after another, a first slide slot and a second slide slot being formed in the tube wall;
b) a sleeve mounted at the external circumference of the fixing tube and having a first through hole and a second through hole corresponding to the first and second slide slots of the fixing tube, respectively;
c) a push tube having one end fixed on the running board, the other end of the push tube being extended into the fixing tube in such a manner that the push tube is screwed with a locating gear and a locating member, the locating member, the sleeve, and the push tube being interlocked by means of a locating screw passing through the first through hole and the first slide slot; and
d) a shock absorption regulator having an adjusting gear set, a motor, and a housing, the adjusting gear set and the motor being received within the housing, the housing being mounted by a fixing member on the external circumference of the sleeve, a drive gear of the adjusting gear set passing through the second through hole and the second slide slot in such a way that the drive gear is engaged with the locating gear.

2. The shock absorption apparatus for a treadmill as recited in claim 1 wherein the fixing tube includes a flange for fixing the fixing tube on the lifting frame while the push tube includes a connection member for fixing the push tube on the running board.

3. A shock absorption apparatus for a treadmill interposed between a base and a lifting frame, comprising:
a) a fixing tube having one end fixed on a housing of an elevation adjusting unit, a positioning body being formed at the internal side of the other end of the fixing tube, a positioning member, a locating gear, a locating member, and a damping spring being placed into the fixing tube one after another, a first slide slot and a second slide slot being formed in the tube wall;
b) a sleeve mounted at the external circumference of the fixing tube and having a first through hole and a second through hole corresponding to the first and second slide slots of the fixing tube, respectively;
c) a push tube having one end fixed on the lifting frame, the other end of the push tube being extended into the fixing tube in such a manner that the push tube is screwed with a locating gear and a locating member, the locating member, the sleeve, and the push tube being interlocked by means of a locating screw passing through the first through hole and the first slide slot;
d) a shock absorption regulator having an adjusting gear set, a motor, and a housing, the adjusting gear set and the motor being received within the housing, the housing being mounted by a fixing member on the external circumference of the sleeve, a drive gear of the adjusting gear set passing through the second through hole and the second slide slot in such a way that the drive gear is engaged with the locating gear; and
e) an elevation adjusting unit having a transmission gear set installed within a housing, a transmission bar and the transmission gear set creating a power transmission unit, one end of the transmission bar being pivotally connected to the base while the other end thereof is extended into the damping spring and the push tube, a motor being employed to provide the drive force required by the transmission gear set.

4. The shock absorption apparatus for a treadmill as recited in claim 3 wherein the fixing tube includes a flange for fixing the fixing tube on a housing of the elevation adjusting unit while the push tube includes a connection member at one end thereof for fixing the push tube on the running board.

5. The shock absorption apparatus for a treadmill as recited in claim 3 wherein the transmission bar is a spindle or a rack.
